(19) United States
(12) Patent Application Publication
(10) Pub. No.: US 2025/0377469 A1
(43) Pub. Date: Dec. 11, 2025

(54) METHODS FOR ELASTIC VECTOR REFLECTIVITY WAVEFORM INVERSION

(71) Applicant: Schlumberger Technology Corporation, Sugar Land, TX (US)

(72) Inventor: James E. Rickett, Crawley (GB)

(21) Appl. No.: 19/231,151

(22) Filed: Jun. 6, 2025

Related U.S. Application Data
(60) Provisional application No. 63/658,011, filed on Jun. 10, 2024.

(51) Int. Cl. G01V 1/28; G01V 1/30

(52) U.S. Cl. CPC G01V 1/282; G01V 1/306; G01V 2210/614; G01V 2210/6226

(57) ABSTRACT

A method for generating an earth model is disclosed. The method includes receiving input data. The input data includes an initial earth model and observed seismic data. The method also includes determining a high spatial frequency component and a low spatial frequency component based on the input data. The method further includes preparing a full bandwidth model based on the high spatial frequency component and the low spatial frequency component. The method also includes generating synthetic seismic data using the full bandwidth model. The method also includes generating the earth model based on the synthetic seismic data and the observed seismic data.

### CROSS-REFERENCE TO RELATED APPLICATIONS

This application claims priority to U.S. Provisional Patent Application No. 63/658,011 filed on Jun. 10, 2024, the contents of which are incorporated by reference to the extent consistent with the present disclosure.

### BACKGROUND

Full Waveform Inversion (FWI) is a high-resolution seismic imaging technique that reconstructs subsurface properties by minimizing the difference between observed and simulated seismic data. The accuracy and efficiency of FWI may be influenced by the choice of inversion parameters, which may determine the formulation and solution of the underlying nonlinear inverse problem. Due to the highly nonlinear nature of FWI, particularly in complex geological settings, the selection of model parameters may directly impacts the domain of attraction. Furthermore, the parameter choices may also significantly slow the rate of convergence. Conventional FWI methods may often focus on recovering scalar physical parameters such as acoustic velocity or impedance, without explicitly modeling seismic vector reflectivity. As a result, the conventional methods may fail to capture important anisotropic or angle-dependent scattering effects, limiting the resolution and fidelity of the inverted models.

What is needed, then, are methods for Full Waveform Inversion and generating an earth model that incorporates seismic vector reflectivity.

### SUMMARY

A method for generating an earth model is disclosed. The method includes receiving input data. The input data may include an initial earth model and observed seismic data. The method may also include determining a high spatial frequency component and a low spatial frequency component based on the input data. The method may further include preparing a full bandwidth model based on the high spatial frequency component and the low spatial frequency component. The method may also include generating synthetic seismic data using the full bandwidth model. The method may also include generating the earth model based on the synthetic seismic data and the observed seismic data.

A computing system is also disclosed. The computing system includes one or more processors and a memory system. The memory system includes one or more non-transitory computer-readable media storing instructions that, when executed by at least one of the one or more processors, cause the computing system to perform operations. The operations include receiving input data. The input data may include an initial earth model and observed seismic data, and wherein the initial earth model comprises an initial seismic vector reflectivity (R_{B}), an initial velocity (vₚ), or any combination thereof. The operations also include determining a high spatial frequency component based on the initial seismic vector reflectivity (R_{B}). The operations further include determining a low spatial frequency component using the initial earth model. Determining the low spatial frequency component includes determining an empirical component using the initial earth model based on an empirical model. Determining the low spatial frequency component also includes determining the low spatial frequency component based on the empirical component. The operations also include preparing a full bandwidth model based on the high spatial frequency component and the low spatial frequency component. The operations also include generating synthetic seismic data using the full bandwidth model. The operations also include generating the earth model based on the synthetic seismic data and the observed seismic data.

A non-transitory computer-readable medium is also disclosed. The medium stores instructions that, when executed by one or more processors of a computing system, cause the computing system to perform operations. The operations include receiving input data. The input data includes an initial earth model and observed seismic data, The initial earth model includes an initial seismic vector reflectivity (R_{B}) and an initial velocity (vₚ). The initial seismic vector reflectivity includes an acoustic reflectivity, an elastic impedance, a gradient of an impedance property, or a combination thereof. The operations also include determining a high spatial frequency component based on the gradient of the impedance property. The operations also include determining a low spatial frequency component based on the initial velocity (vₚ) of the initial earth model. Determining the low spatial frequency component includes: determining an empirical component with the initial velocity (vₚ) using an empirical model; and applying a low pass filtering to the empirical component to determine the low spatial frequency component. The operations also include preparing a full bandwidth model based on the high spatial frequency component and the low spatial frequency component. The operations also include generating synthetic seismic data using the full bandwidth model. The operations also include generating the earth model based on the synthetic seismic data and the observed seismic data. Generating the earth model includes comparing the synthetic seismic data with the observed seismic data.

It will be appreciated that this summary is intended merely to introduce some aspects of the present methods, systems, and media, which are more fully described and/or claimed below. Accordingly, this summary is not intended to be limiting.

### BRIEF DESCRIPTION OF THE DRAWINGS

The accompanying drawings, which are incorporated in and constitute a part of this specification, illustrate embodiments of the present teachings and together with the description, serve to explain the principles of the present teachings.

FIG. 1 illustrates an example computing system, according to an embodiment.

FIG. 2 illustrates a survey operation being performed by a survey tool to measure properties of the subterranean formation, according to an embodiment.

FIG. 3A illustrates a drilling operation being performed by drilling tools suspended by a rig and advanced into subterranean formations to form a wellbore, according to an embodiment.

FIG. 3B illustrates a wireline operation being performed by a wireline tool suspended by the rig and into the wellbore of FIG. 3A, according to an embodiment.

FIG. 3C illustrates a production operation being performed by a production tool deployed from a production unit or Christmas tree and into the completed wellbore for drawing fluid from the downhole reservoirs into the surface facilities, according to an embodiment.

FIG. 4 illustrates a schematic view, partially in cross section of an oilfield having data acquisition tools positioned at various locations along an oilfield for collecting data of a subterranean formation, according to an embodiment.

FIG. 5 illustrates an oilfield for performing production operations, according to an embodiment.

FIG. 6 illustrates an exemplary forward modeling process for generating seismic data from velocity and reflectivity, according to an embodiment.

FIG. 7 illustrates a flowchart of a method for generating an earth model, according to an embodiment.

### DETAILED DESCRIPTION

Reference will now be made in detail to embodiments, examples of which are illustrated in the accompanying drawings and figures. In the following detailed description, numerous specific details are set forth in order to provide a thorough understanding of the present disclosure. However, it will be apparent to one of ordinary skill in the art that the present disclosure may be practiced without these specific details. In other instances, well-known methods, procedures, components, circuits and networks have not been described in detail so as not to unnecessarily obscure aspects of the embodiments.

It will also be understood that, although the terms first, second, etc., may be used herein to describe various elements, these elements should not be limited by these terms. These terms are used to distinguish one element from another. For example, a first object or step could be termed a second object or step, and, similarly, a second object or step could be termed a first object or step, without departing from the scope of the present disclosure. The first object or step, and the second object or step, are both objects or steps, respectively, but they are not to be considered the same object or step.

The terminology used in the description of the present disclosure herein is for the purpose of describing particular embodiments and is not intended to be limiting of the present disclosure. As used in the description of the present disclosure and the appended claims, the singular forms “a,” “an” and “the” are intended to include the plural forms as well, unless the context clearly indicates otherwise. It will also be understood that the term “and/or” as used herein refers to and encompasses any possible combination of one or more of the associated listed items. It will be further understood that the terms “includes,” “including,” “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” may be construed to mean “when” or “upon” or “in response to determining” or “in response to detecting,” depending on the context.

Those with skill in the art will appreciate that while some terms in this disclosure may refer to absolutes, e.g., all of the components of a wavefield, all source receiver traces, each of a plurality of objects, etc., the methods and techniques disclosed herein may also be performed on fewer than all of a given thing, e.g., performed on one or more components and/or performed on one or more source receiver traces. Accordingly, in instances in the disclosure where an absolute Error! Bookmark not defined. is used, the disclosure may also be interpreted to be referring to a subset.

### Computing Systems

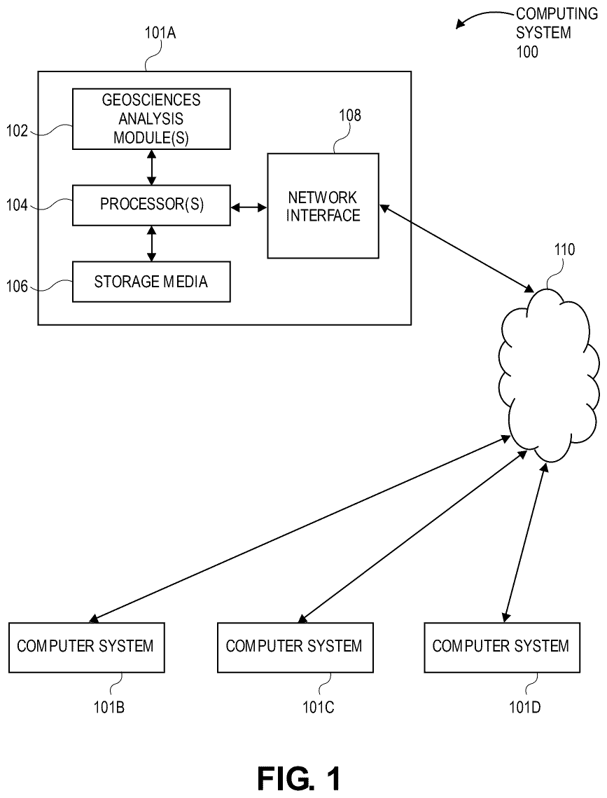

FIG. 1 depicts an example computing system 100 in accordance with some embodiments. The computing system 100 can be an individual computer system 101A or an arrangement of distributed computer systems. The computer system 101A includes one or more geosciences analysis modules 102 that are configured to perform various tasks according to some embodiments, such as one or more methods disclosed herein. To perform these various tasks, geosciences analysis module 102 executes independently, or in coordination with, one or more processors 104, which is (or are) connected to one or more storage media 106. The processor(s) 104 is (or are) also connected to a network interface 108 to allow the computer system 101A to communicate over a data network 110 with one or more additional computer systems and/or computing systems, such as 101B, 101C, and/or 101D (note that computer systems 101B, 101C and/or 101D may or may not share the same architecture as computer system 101A, and may be located in different physical locations, e.g., computer systems 101A and 101B may be on a ship underway on the ocean, while in communication with one or more computer systems such as 101C and/or 101D that are located in one or more data centers on shore, other ships, and/or located in varying countries on different continents). Note that data network 110 may be a private network, it may use portions of public networks, it may include remote storage and/or applications processing capabilities (e.g., cloud computing).

A processor can include a microprocessor, microcontroller, processor module or subsystem, programmable integrated circuit, programmable gate array, or another control or computing device.

The storage media 106 can be implemented as one or more computer-readable or machine-readable storage media. Note that while in the example embodiment of FIG. 1 storage media 106 is depicted as within computer system 101A, in some embodiments, storage media 106 may be distributed within and/or across multiple internal and/or external enclosures of computing system 101A and/or additional computing systems. Storage media 106 may include one or more different forms of memory including semiconductor memory devices such as dynamic or static random access memories (DRAMs or SRAMs), erasable and programmable read-only Error! Bookmark not defined. memories (EPROMs), electrically erasable and programmable read-only memories (EEPROMs) and flash memories; magnetic disks such as fixed, floppy and removable disks; other magnetic media including tape; optical media such as compact disks (CDs) or digital video disks (DVDs), BluRays or any other type of optical media; or other types of storage devices. Note that the instructions discussed above can be provided on one computer-readable or machine-readable storage medium, or alternatively Error! Bookmark not defined, can be provided on multiple computer-readable or machine-readable storage media distributed in a large system having possibly plural nodes and/or non-transitory storage means. Such computer-readable or machine-readable storage medium or media is (are) considered to be part of an article (or article of manufacture). An article or article of manufacture can refer to any manufactured single component or multiple components. The storage medium or media can be located either in the machine running the machine-readable instructions, or located at a remote site from which machine-readable instructions can be downloaded over a network for execution.

It should be appreciated that computer system 101A is one example of a computing system, and that computer system 101A may have more or fewer components than shown, may combine additional components not depicted in the example embodiment of FIG. 1, and/or computer system 101A may have a different configuration or arrangement of the components depicted in FIG. 1. The various components shown in FIG. 1 may be implemented in hardware, software, or a combination of both, hardware and software, including one or more signal processing and/or application specific integrated circuits.

It should also be appreciated that while no user input/output peripherals are illustrated with respect to computer systems 101A, 101B, 101C, and 101D, many embodiments of computing system 100 include computer systems with keyboards, mice, touch screens, displays, etc. Some computer systems in use in computing system 100 may be desktop workstations, laptops, tablet computers, smartphones, server computers, etc.

Further, the steps in the processing methods described herein may be implemented by running one or more functional modules in information processing apparatus such as general purpose processors or application specific chips, such as ASICs, FPGAs, PLDs, or other appropriate devices. These modules, combinations of these modules, and/or their combination with general hardware are included within the scope of protection.

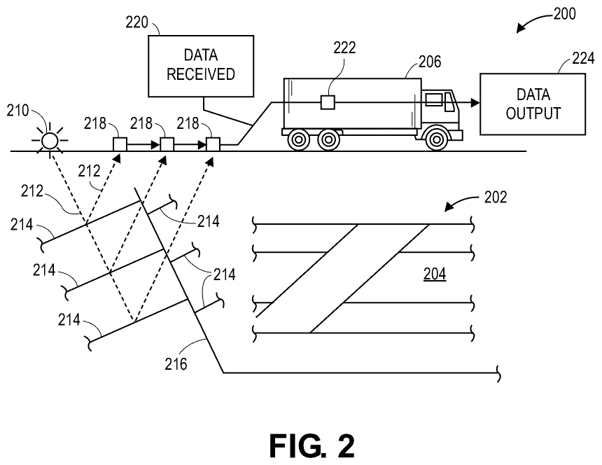

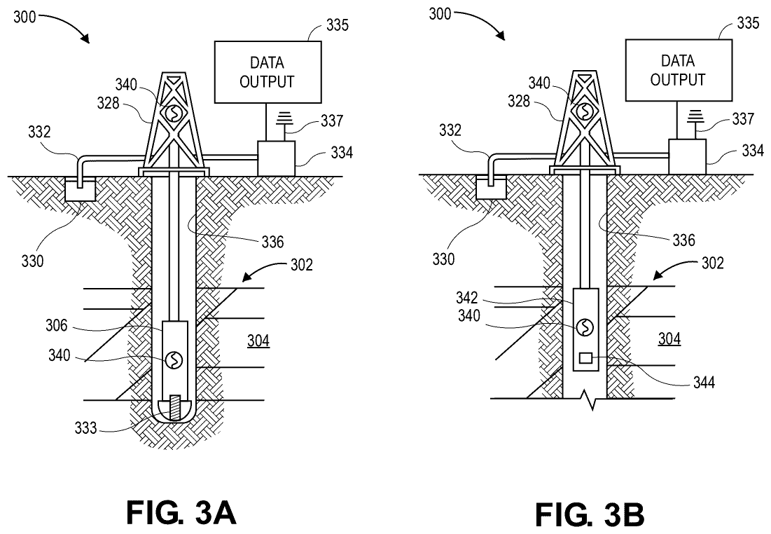

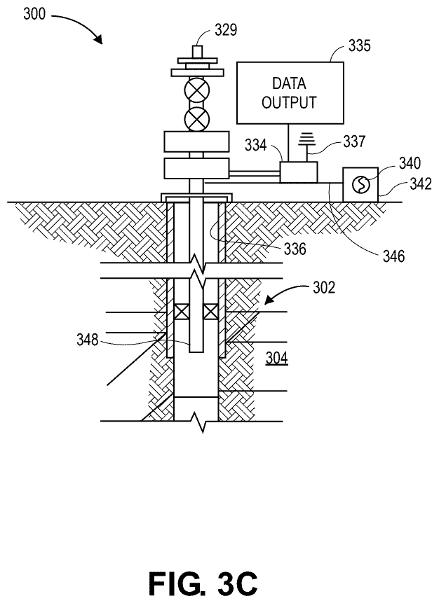

FIGS. 2 and 3A-3C generally illustrate simplified, schematic views of oilfield 200, 300 having subterranean formation 202 containing reservoir 204 therein in accordance with implementations of various technologies and techniques described herein.

FIG. 2 illustrates a survey operation being performed by a survey tool, such as seismic truck 206, to measure properties of the subterranean formation. The survey operation is a seismic survey operation for producing sound vibrations. In FIG. 2, one such sound vibration, e.g., sound vibration 212 generated by source 210, reflects off horizons 214 in earth formation 216. A set of sound vibrations is received by sensors, such as geophone-receivers 218, situated on the earth's surface. The data received 220 is provided as input data to a computer 222 of a seismic truck 206, and responsive to the input data, computer 222 generates seismic data output 224. This seismic data output may be stored, transmitted or further processed as desired, for example, by data reduction.

FIG. 3A illustrates a drilling operation being performed by drilling tools 306 suspended by rig 328 and advanced into subterranean formations 302 to form wellbore 336. Mud pit 330 is used to draw drilling mud into the drilling tools via flow line 332 for circulating drilling mud down through the drilling tools, then up wellbore 336 and back to the surface. The drilling mud is typically filtered and returned to the mud pit. A circulating system may be used for storing, controlling, or filtering the flowing drilling mud. The drilling tools are advanced into subterranean formations 302 to reach reservoir 304. Each well may target one or more reservoirs. The drilling tools are adapted for measuring downhole properties using logging while drilling tools. The logging while drilling tools may also be adapted for taking core sample 333 as shown.

Computer facilities may be positioned at various locations about the oilfield 300 (e.g., the surface unit 334) and/or at remote locations. Surface unit 334 may be used to communicate with the drilling tools and/or offsite operations, as well as with other surface or downhole sensors. Surface unit 334 is capable of communicating with the drilling tools to send commands to the drilling tools, and to receive data therefrom. Surface unit 334 may also collect data generated during the drilling operation and produce data output 335, which may then be stored or transmitted.

Sensors 340, such as gauges, may be positioned about oilfield 300 to collect data relating to various oilfield operations as described previously. As shown, sensor 340 is positioned in one or more locations in the drilling tools and/or at rig 328 to measure drilling parameters, such as weight on bit, torque on bit, pressures, temperatures, flow rates, compositions, rotary speed, and/or other parameters of the field operation. Sensors 340 may also be positioned in one or more locations in the circulating system.

Drilling tools 306 may include a bottom hole assembly (BHA) (not shown), generally referenced, near the drill bit (e.g., within several drill collar lengths from the drill bit). The bottom hole assembly includes capabilities for measuring, processing, and storing information, as well as communicating with surface unit 334. The bottom hole assembly further includes drill collars for performing various other measurement functions.

The bottom hole assembly may include a communication subassembly that communicates with surface unit 334. The communication subassembly is adapted to send signals to and receive signals from the surface using a communications channel such as mud pulse telemetry, electro-magnetic telemetry, or wired drill pipe communications. The communication subassembly may include, for example, a transmitter that generates a signal, such as an acoustic or electromagnetic signal, which is representative of the measured drilling parameters. It will be appreciated by one of skill in the art that a variety of telemetry systems may be employed, such as wired drill pipe, electromagnetic or other known telemetry systems.

Typically, the wellbore is drilled according to a drilling plan that is established prior to drilling. The drilling plan typically sets forth equipment, pressures, trajectories and/or other parameters that define the drilling process for the wellsite. The drilling operation may then be performed according to the drilling plan. However, as information is gathered, the drilling operation may need to deviate from the drilling plan. Additionally, as drilling or other operations are performed, the subsurface conditions may change. The earth model may also need adjustment as new information is collected

The data gathered by sensors 340 may be collected by surface unit 334 and/or other data collection sources for analysis or other processing. The data collected by sensors 340 may be used alone or in combination with other data. The data may be collected in one or more databases and/or transmitted on or offsite. The data may be historical data, real time data, or combinations thereof. The real time data may be used in real time or stored for later use. The data may also be combined with historical data or other inputs for further analysis. The data may be stored in separate databases, or combined into a single database.

Surface unit 334 may include transceiver 337 to allow communications between surface unit 334 and various portions of the oilfield 300 or other locations. Surface unit 334 may also be provided with or functionally connected to one or more controllers (not shown) for actuating mechanisms at oilfield 300. Surface unit 334 may then send command signals to oilfield 300 in response to data received. Surface unit 334 may receive commands via transceiver 337 or may itself execute commands to the controller. A processor may be provided to analyze the data (locally or remotely), make the decisions and/or actuate the controller. In this manner, oilfield 300 may be selectively adjusted based on the data collected. This technique may be used to optimize (or improve) portions of the field operation, such as controlling drilling, weight on bit, pump rates, or other parameters. These adjustments may be made automatically based on computer protocol, and/or manually by an operator. In some cases, well plans may be adjusted to select optimum (or improved) operating conditions, or to avoid problems.

FIG. 3B illustrates a wireline operation being performed by wireline tool 306 suspended by rig 328 and into wellbore 336 of FIG. 3A. Wireline tool 342 is adapted for deployment into wellbore 336 for generating well logs, performing downhole tests and/or collecting samples. Wireline tool 342 may be used to provide another method and apparatus for performing a seismic survey operation. Wireline tool 342 may, for example, have an explosive, radioactive, electrical, or acoustic energy source 344 that sends and/or receives electrical signals to surrounding subterranean formations 302 and fluids therein.

Wireline tool 342 may be operatively connected to, for example, geophones 218 and a computer 222 of a seismic truck 206 of FIG. 2. Wireline tool 342 may also provide data to surface unit 334. Surface unit 334 may collect data generated during the wireline operation and may produce data output 335 that may be stored or transmitted. Wireline tool 342 may be positioned at various depths in the wellbore 336 to provide a survey or other information relating to the subterranean formation 302.

Sensors 340, such as gauges, may be positioned about oilfield 300 to collect data relating to various field operations as described previously. As shown in FIG. 3B, sensor 340 is positioned in wireline tool 342 to measure downhole parameters which relate to, for example porosity, permeability, fluid composition and/or other parameters of the field operation.

FIG. 3C illustrates a production operation being performed by production tool 348 deployed from a production unit or Christmas tree 329 and into completed wellbore 336 for drawing fluid from the downhole reservoirs into surface facilities 342. The fluid flows from reservoir 304 through perforations in the casing (not shown) and into production tool 348 in wellbore 336 and to surface facilities 342 via gathering network 346.

Sensors 340, such as gauges, may be positioned about oilfield 300 to collect data relating to various field operations as described previously. As shown, the sensor 340 may be positioned in production tool 348 or associated equipment, such as Christmas tree 329, gathering network 346, surface facility 342, and/or the production facility, to measure fluid parameters, such as fluid composition, flow rates, pressures, temperatures, and/or other parameters of the production operation.

Production may also include injection wells for added recovery. One or more gathering facilities may be operatively connected to one or more of the wellsites for selectively collecting downhole fluids from the wellsite(s).

While FIGS. 3A-3C illustrate tools used to measure properties of an oilfield, it will be appreciated that the tools may be used in connection with non-oilfield operations, such as gas fields, mines, aquifers, storage or other subterranean facilities. Also, while certain data acquisition tools are depicted, it will be appreciated that various measurement tools capable of sensing parameters, such as seismic two-way travel time, density, resistivity, production rate, etc., of the subterranean formation and/or its geological formations may be used. Various sensors 340 may be located at various positions along the wellbore and/or the monitoring tools to collect and/or monitor the desired data. Other sources of data may also be provided from offsite locations.

The field configurations of FIGS. 2 and 3A-3C are intended to provide a brief description of an example of a field usable with oilfield application frameworks. Part of, or the entirety Error! Bookmark not defined., of oilfield 200, 300 may be on land, water, and/or sea. Also, while a single field measured at a single location is depicted, oilfield applications may be utilized with any combination of one or more oilfields, one or more processing facilities and one or more wellsites.

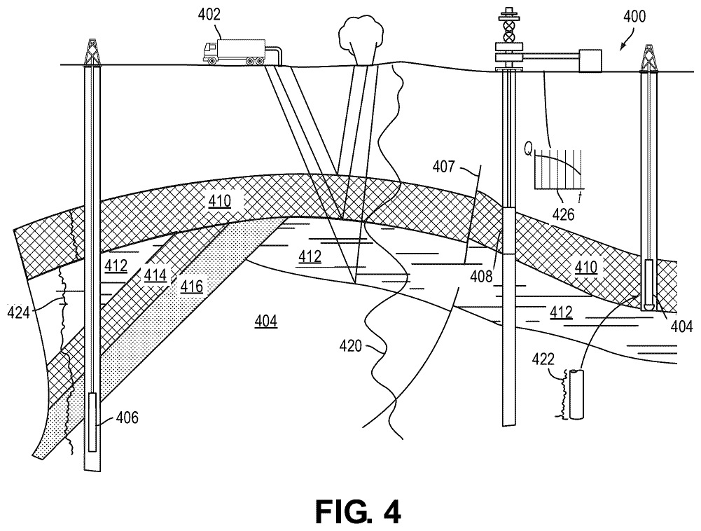

FIG. 4 illustrates a schematic view, partially in cross section of oilfield 400 having data acquisition tools 402, 404, 406 and 408 positioned at various locations along oilfield 400 for collecting data of subterranean formation 404 in accordance with implementations of various technologies and techniques described herein. Data acquisition tools 402-408 may be the same as data acquisition tools 206, 306, 342, 348 of FIGS. 2-3C, respectively, or others not depicted. As shown, data acquisition tools 402-408 generate data plots or measurements 420, 422, 424, 426, respectively. These data plots are depicted along oilfield 400 to demonstrate the data generated by the various operations.

Data plots 420-424 are examples of static data plots that may be generated by data acquisition tools 402-406, respectively; however, it should be understood that data plots 420-424 may also be data plots that are updated in real time. These measurements may be analyzed to better define the properties of the formation(s) and/or determine the accuracy of the measurements and/or for checking for errors. The plots of each of the respective measurements may be aligned and scaled for comparison and verification of the properties.

Static data plot 420 is a seismic two-way response over a period of time. Static plot 422 is core sample data measured from a core sample of the formation 404. The core sample may be used to provide data, such as a graph of the density, porosity, permeability, or some other physical property of the core sample over the length of the core. Tests for density and viscosity may be performed on the fluids in the core at varying pressures and temperatures. Static data plot 424 is a logging trace that typically Error! Bookmark not defined. provides a resistivity or other measurement of the formation at various depths.

A production decline curve or graph 426 is a dynamic data plot of the fluid flow rate over time. The production decline curve typically Error! Bookmark not defined. provides the production rate as a function of time. As the fluid flows through the wellbore, measurements are taken of fluid properties, such as flow rates, pressures, composition, etc.

Other data may also be collected, such as historical data, user inputs, economic information, and/or other measurement data and other parameters of interest. As described below, the static and dynamic measurements may be analyzed and used to generate models of the subterranean formation to determine characteristics thereof. Similar measurements may also be used to measure changes in formation aspects over time.

The subterranean structure 404 has a plurality of geological formations 410-416. As shown, this structure has several formations or layers, including a shale layer 410, a carbonate layer 412, a shale layer 414 and a sand layer 416. A fault 407 extends through the shale layer 410 and the carbonate layer 412. The static data acquisition tools are adapted to take measurements and detect characteristics of the formations.

While a specific subterranean formation with specific geological structures is depicted, it will be appreciated that oilfield 400 may contain a variety of geological structures and/or formations, sometimes having extreme complexity. In some locations, typically Error! Bookmark not defined. below the water line, fluid may occupy pore spaces of the formations. Each of the measurement devices may be used to measure properties of the formations and/or its geological features. While each acquisition tool is shown as being in specific locations in oilfield 400, it will be appreciated that one or more types of measurement may be taken at one or more locations across one or more fields or other locations for comparison and/or analysis.

The data collected from various sources, such as the data acquisition tools of FIG. 4, may then be processed and/or evaluated. Typically Error! Bookmark not defined., seismic data displayed in static data plot 420 from data acquisition tool 402 is used by a geophysicist to determine characteristics of the subterranean formations and features. The core data shown in static plot 422 and/or log data from well log 424 are typically used by a geologist to determine various characteristics of the subterranean formation. The production data from graph 426 is typically used by the reservoir engineer to determine fluid flow reservoir characteristics. The data analyzed by the geologist, geophysicist and the reservoir engineer may be analyzed using modeling techniques.

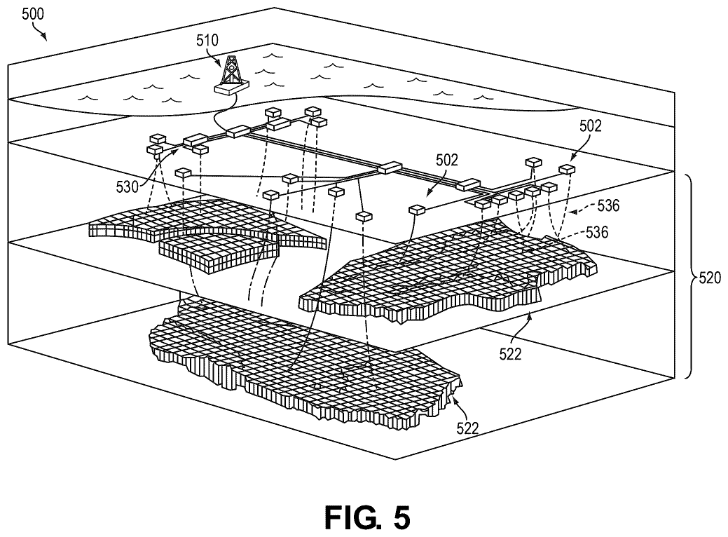

FIG. 5 illustrates an oilfield 500 for performing production operations in accordance with implementations of various technologies and techniques described herein. As shown, the oilfield has a plurality of wellsites 502 operatively connected to central processing facility 510. The oilfield configuration of FIG. 5 is not intended to limit the scope of the oilfield application system. Part, or all Error! Bookmark not defined., of the oilfield may be on land and/or sea. Also, while a single oilfield with a single processing facility and a plurality of wellsites is depicted, any combination of one or more oilfields, one or more processing facilities and one or more wellsites may be present.

Each wellsite 502 has equipment that forms wellbore 536 into the earth. The wellbores extend through subterranean formations 520 including reservoirs 522. These reservoirs 522 contain fluids, such as hydrocarbons. The wellsites draw fluid from the reservoirs and pass them to the processing facilities via surface networks 530. The surface networks 530 have tubing and control mechanisms for controlling the flow of fluids from the wellsite to processing facility 510.

Attention is now directed to methods, techniques, and workflows for processing and/or transforming collected data that are in accordance with some embodiments. Some operations in the processing procedures, methods, techniques, and workflows disclosed herein may be combined and/or the order of some operations may be changed. Those with skill in the art will recognize that in the geosciences and/or other multi-dimensional data processing disciplines, various interpretations, sets of assumptions, and/or domain models such as velocity models, may be refined in an iterative fashion; this concept is applicable to the procedures, methods, techniques, and workflows as discussed herein. This iterative refinement can include use of feedback loops executed on an algorithmic basis, such as at a computing device (e.g., computing system 100, FIG. 1), and/or through manual control by a user who may make determinations regarding whether a given step Error! Bookmark not defined., action, template, or model has become sufficiently accurate.

It should be appreciated that the choice of model parameterization may affect, at least in part, the results of Full Waveform Inversion (FWI) as it affects many things, including the nonlinearity of the inverse problem, the domain of attraction, and the speed of convergence. Seismic reflectivity may be an ideal parameter for inversion as it may be associated with a linear or substantially linear relationship with seismic reflection amplitudes.

The present disclosure enables inversion using seismic vector reflectivity as a parameter in FWI. This leads to faster convergence of multi-parameter FWI especially for high-frequency applications. Further, elastic impedance and corresponding elastic reflectivity parameters may be defined to enable pre-stack amplitude-vs-angle (AVA) effects to be captured with elastic FWI. The foregoing may enable a range of quantitative interpretation (QI) workflows that may be used to characterize lithology and information about pore fluid.

It should be appreciated that vector reflectivity may be determined or calculated from one or more volumetric earth properties via a gradient operation. However, the inverse process
the transformation from the vector reflectivity to volumetric earth properties—may not be well-posed, as the gradient operation may not preserve one or more low frequencies. As further disclosed herein in detail, the damped inverse of the gradient operation may be complemented with a low-spatial frequency component derived from a velocity model using or based on an empirical relationship.

The foregoing enables the determination of a forward modelling process that may initiate or start from the velocity and reflectivity, transform the velocity and reflectivity to the volumetric earth properties (e.g., acoustic or elastic), and then generate synthetic seismic data using a traditional or conventional modeling scheme. The forward modelling process may be inverted using or based on a chain rule and/or machinery of the Full Waveform Inversion, to produce an earth model described or defined, at least in part, by the velocity and reflectivity. Additionally, an elastic reflectivity parameter may be defined as a gradient of an elastic impedance function that may capture a first-order amplitude-vs-angle (AVA) behavior of the seismic reflections. Elastic reflectivity may be used as a parameter in FWI with an acoustic reflectivity according the present disclosure.

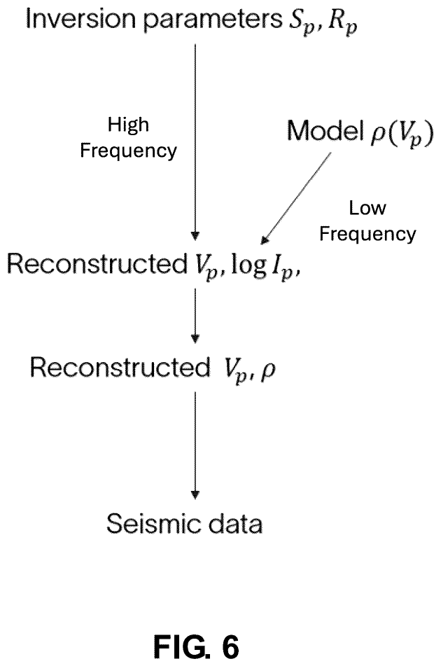

FIG. 6 illustrates an exemplary forward modeling process for generating seismic data from velocity and reflectivity. One or more high frequency components of impedance derived from reflectivity may be complemented by one or more low-frequency components derived from the velocity model and an empirical relationship or empirical model. The forward modeling process may be inverted using the machinery of FWI and/or the chain rule.

### Acoustic and Elastic Reflectivity

A zero-offset reflection coefficient may be given by a contrast in acoustic impedance across a boundary according to Equation (1):

$${R}_{0} = \frac{1}{2} ( \frac{Δ {v}_{p}}{{v}_{p}} + \frac{Δ ρ}{ρ} ) \qquad ( 1 )$$

It should be appreciate that A may be defined as the logarithm of the acoustic impedance according to Equation (2) to thereby provide Equation (3).

$$A ( {v}_{p} , ρ ) = log {v}_{p} ρ \qquad ( 2 )$$

$$δ A = \frac{1}{{v}_{p}} δ {v}_{p} + \frac{1}{ρ} δ ρ = 2 {R}_{0} \qquad ( 3 )$$

The foregoing may provide or lead to the derivative of log-impedance (VIp) being a natural parameter for inversion as it may be linearly related to zero-offset seismic amplitudes. If this quantity is held constant, then the first-order near-offset amplitudes may remain constant.

In at least one embodiment, a step (e.g., first step) after the zero-offset acoustic impedance modeling may be amplitude-vs-angle (AVA) modeling with a two-term Shuey equation. In terms of parameters (vₚ, vₛ, ρ), this may be provided or determined according to Equation (4):

$$R ( θ ) = {R}_{0} + G {sin}^{2} θ , \qquad ( 4 )$$

$$where :$$

$$G ( {v}_{p} , {v}_{s} , ρ ) = \frac{1}{2} \frac{Δ {v}_{p}}{{v}_{p}} - 2 \frac{{v}_{s}^{2}}{{v}_{p}^{2}} ( \frac{Δ ρ}{ρ} + 2 \frac{Δ {v}_{s}}{{v}_{s}} )$$

The low-frequency vₚ to vₛ ratio may not be well resolved by P-wave reflection amplitudes and may be defined by an a-prior model for β=vₛ/vₚ that may be consider as a constant. In view of the foregoing, a new elastic property may be defined according to Equation (5); and taking the total derivative of B provides Equation (6).

$$B ( {v}_{p} , {v}_{s} , ρ ) = log ( {v}_{p} {v}_{s}^{- 8 {β}^{2}} {ρ}^{- 4 {β}^{2}} ) \qquad ( 5 )$$

$$δ B = \frac{1}{{v}_{p}} δ {v}_{p} - \frac{8 {β}^{2}}{{v}_{s}} δ {v}_{s} - \frac{4 {β}^{2}}{ρ} δ ρ = 2 G \qquad ( 6 )$$

Accordingly, in the same way that the log acoustic impedance may isolate the zero-offset reflectivity, B may isolate the AVO-gradient (sin-squared) behavior of pre-stack elastic reflectivity. Under the assumptions of the Shuey approximation and a fixed vₚ/vₛ ratio, it may have a linear or substantially linear relation to the key AVO properties of the data. This makes it attractive as an inversion parameter.

B may be a form of elastic impedance as introduced by Connolly (1998) for prestack quantitative interpretation applications. (P. Connolly, 1999, Elastic Impedance, The Leading Edge, 18:438-452). It should be appreciated, however, that other variations of a similar form may be possible. In at least one embodiment, the foregoing may be utilized as a parameter for elastic FWI.

For inversion purposes, an earth model may be defined or determined in terms of (sₚ=1/vₚ, ∇A, ∇B). The forward modelling process may then be integrate to (sₚ, A, B), and then transform to (vₚ, vₛ, ρ) for the modeling of elastic wave propagation. Since the modelling itself may be fully elastic, it may not be constrained by the constant 8 parameter or by the two-term reflectivity modelling equation. These assumptions may only impact the degree to which the parameters linearly relate to the AVO properties of the data.

In the water layer, B the above definition may be undefined. However, its limiting behavior may be defined such that as vₛ→0, then

$${v}_{s}^{- 8 {β}^{2}} \to 1 .$$

As such, the definition of B, as discussed above, may be extended to cover a case where vₛ→0 with B(vₚ, vₛ=0, ρ)=log vₚ.
Modeling from Vector Reflectivity

Vector reflectivity may be defined as the gradient of log-impedance according to Equation (7).

$${R}_{A} = ( \begin{matrix}\partial / \partial x \\ \partial / \partial y \\ \partial / \partial z\end{matrix} ) A = ∇ A \qquad ( 7 )$$

The gradient operator may not be a square matrix. As such, the gradient operator may not be directly invertible. It should be appreciated, however, that its damped least-squares inverse may be defined according to Equation (8):

$${A}_{est} = {∇}^{†} R = {( {∇}^{′} ∇ + {ϵ}^{2} I )}^{- 1} {∇}^{′} {R}_{A} . \qquad ( 8 )$$

And implemented in the frequency domain according to Equation (9) and (10):

$$∇ \hat{A} = i ( \begin{matrix}{k}_{x} \\ {k}_{y} \\ {k}_{z}\end{matrix} ) \qquad ( 9 )$$

$$\hat{A} ( {k}_{x} , {k}_{y} , {k}_{z} ) = i \frac{{k}_{x} {\hat{R}}_{x} + {k}_{y} {\hat{R}}_{y} + {k}_{z} {\hat{R}}_{z}}{{k}_{x}^{2} + {k}_{y}^{2} + {k}_{z}^{2} + {ϵ}^{2}} \qquad ( 10 )$$

where the hat notation may indicate that the property is Fourier transformed in a spatial three dimensions. The stabilization may prevent recovery of the low spatial frequencies with wavelength λ≲2π/ϵ; however, the low spatial frequencies may be estimated from the current vₚ model using a vₚ→ρ model according to Equation (11):

$$A ( {v}_{p} , {R}_{A} ) = ( I - {∇}^{†} ∇ ) [ {f}_{{v}_{p} \to A} ( {v}_{p} ) ] + {∇}^{†} {R}_{A} \qquad ( 11 )$$

$$where :$$

$${f}_{{v}_{p} \to A} ( {v}_{p} ) = log {v}_{p} + log [ {f}_{{v}_{p} \to ρ} ( {v}_{p} ) ]$$

The operator (I-∇^{†}∇) may act as a low-pass, allowing the low and/or high frequency components to be blended with one another. It should be appreciated that if the reflectivity is the gradient of A, and the vₚ→ρ is accurate at low frequencies, then the two components may be complements to each other, and the reconstruction will be accurate.

The low-pass operation may be implemented in the frequency domain according to Equation (12):

$$( I - {∇}^{†} ∇ ) = \frac{{ϵ}^{2}}{{k}_{x}^{2} + {k}_{y}^{2} + {k}_{z}^{2} + {ϵ}^{2}} \qquad ( 12 )$$

For Gardner's relationship

$$( ρ = κ {v}_{p}^{1 / 4} )$$

the mapping from velocity to A may be determined according to Equation (13):

$${f}_{{v}_{p} \to A} ( {v}_{p} ) = \frac{5}{4} log {v}_{p} + log κ \qquad ( 13 )$$

where for velocity units km/s and density units, g/cm³, K=1.741.

In view of the foregoing, a complete broadband (sₚ, R_{A})→log Iₚ modeling operator may be determined according to Equation (14):

$$A ( {s}_{p} , {R}_{A} ) = log κ - \frac{5}{4} ( I - {∇}^{†} ∇ ) log {s}_{p} + {∇}^{†} {R}_{A} \qquad ( 14 )$$

### Property Modeling

In at least one embodiment, density may be modeled from vₚ and A according to Equation (15):

$$ρ = \frac{{e}^{A}}{{v}_{p}} . \qquad ( 15 )$$

Inversion may suggest or require the adjoint of the linearization according to Equation (16):

$$δ ρ = \frac{{e}^{A}}{{v}_{p}} δ A - \frac{{e}^{A}}{{v}_{p}^{2}} δ {v}_{p} = ρ δ A - \frac{ρ}{{v}_{p}} δ {v}_{p} \qquad ( 16 )$$

Similarly, the vₛ modeling equations may be according to Equation (17):

$${v}_{s} = \frac{{v}_{p}^{b} {e}^{- B b}}{\sqrt{ρ}} = {v}_{p}^{b + 1 / 2} {e}^{- B b - A / 2} \qquad ( 17 )$$

where b=1/8β², with adjoint determined according to Equation (18):

$$δ {v}_{s} = ( b + \frac{1}{2} ) \frac{{v}_{s}}{{v}_{p}} δ {v}_{p} - \frac{{v}_{s}}{2} δ A - b {v}_{s} δ B . \qquad ( 18 )$$

### Advantages Over Previous Methods

Another approach to inverting for vector reflectivity is to parameterize the acoustic wave-equation in terms of velocity and vector reflectivity instead of velocity and density, and then image vector reflectivity directly. (See Whitmore, N. D., et al., “Full wavefield modeling with vector-reflectivity,” 82nd EAGE Conference & Exhibition, Extended Abstracts, 2020; and Whitmore, N. D., et al., “Determining properties of a subterranean formation using an acoustic wave equation with a reflectivity parameterization,” U.S. Patent 2023/0305176 A1). This conventional method requires modification of the imaging condition to extract the three vector rather than just the density perturbation. This may potentially be avoided by using alternative methods that utilize the local dip direction. (McLeman, J., Burgess, T., Sinha, M., Hampson, G., & Thompson, T., “Reflection FWI with an augmented wave equation and quasi-Newton adaptive gradient scheme,” SEG Technical Program Expanded Abstracts, 2021, pp. 667-671).

The present disclosure may require the imaging of just a single density component with the structural dip. Further, the present disclosure may be completely decoupled from the wave propagation code. The wave equation may not be required to be parameterized in terms of velocity and/or reflectivity. Consequently, the methods disclosed herein may operate, function, or otherwise work “out-of-the-box” with any variable-density propagator. The methods disclosed herein may also allow the recovery of the density unambiguously. The foregoing features of the present disclosure are not possible with the alternative/conventional approaches.

### Modeling to Elastic Impedance

In a similar manner to integrating vector reflectivity, B may be recovered by inverting the gradient operator on R_{B} and complementing it on the low-frequency side. In this case, the low-frequency recovery operation may utilize or require both a vₚ→ρ model and a vₚ→vₛ model.

$$B ( {v}_{p} , {R}_{B} ) = ( I - {∇}^{†} ∇ ) [ {f}_{{v}_{p} \to B} ( {v}_{p} ) ] + {∇}^{†} {R}_{B}$$

where the mapping from vₚ to B may be split into contributions from empirical relations that may predict density and vₛ from vₚ:

$${f}_{{v}_{p} \to B} ( {v}_{p} ) = log {v}_{p} - 4 {β}^{2} log [ {f}_{{v}_{p} \to ρ} ( {v}_{p} ) ] - 8 {β}^{2} log [ {f}_{{v}_{p} \to {v}_{s}} ( {v}_{p} ) ]$$

Invoking Gardner and fixed vₛ=βvₚ may provide Equation (19):

$${f}_{{v}_{p} \to B} ( {v}_{p} ) = ( 1 - 9 {β}^{2} ) log {v}_{p} - 4 {β}^{2} log {κβ}^{2} \qquad ( 19 )$$

### Construction of an Orthogonal Basis for Pre-Stack AVO

For a nonlinear problem like elastic FWI it may be difficult to define a rigorously orthogonal basis set. However, if the data may be assumed to be sampled in the angle domain with density s(θ), then an orthogonal pair of bases may have the following:

$$\int s ( θ ) {ϕ}_{1} ( θ ) {ϕ}_{2} ( θ ) d θ = 0$$

Since the AVO behavior of A and B may be well defined, it may be relatively more simple to create a linear combination of them that has this property for given angle sampling, and potentially normalize as well.

The present disclosure may provide one or more methods for defining an earth model representation in terms of velocity, reflectivity, or a combination thereof. The present disclosure may also provide one or more methods for a forward modeling process that may convert the velocity and reflectivity representation to volumetric properties, and then to seismic data, using an empirical model to complement the reflectivity on the low frequency side or component. The present disclosure may also provide one or more methods for inverting the forward modeling process to optimally update the velocity and reflectivity earth model representation. The method may include using the adjoint-state method to determine or calculate the gradient with respect to volumetric properties, and then chain rule to link this to the gradient with respect to velocity and reflectivity.

In at least one embodiment, one or more of the velocities may be parameterized as slowness. The anisotropy may be included or may form a portion of the velocity. The reflectivity may include acoustic reflectivity: the derivative of impedance or log-impedance. The reflectivity may include elastic impedance that may capture AVA behavior of the seismic reflections. The reflectivity may include a combination of acoustic and elastic impedance to increase orthogonality of one or more model parameters. The empirical relationship may include Gardner's relationship to predict density from velocity. The empirical relationship may include an a-prior vₚ/vₛ model to predict vₛ from velocity. One or more empirical models may be utilized or used in one or more parts of the model (e.g. water different from sediment different from salt). The inversion may involve a single iteration, such that the process may produce migration to acoustic and/or elastic vector reflectivity. The velocity may not be updated in the inversion, such that the process may produce a nonlinear least-squares migration to acoustic and/or elastic vector reflectivity. The vector components of vector reflectivity may be condensed to a single FWI-derived reflectivity product. The FWI-derived reflectivity product may be an elastic FWI-derived reflectivity product.

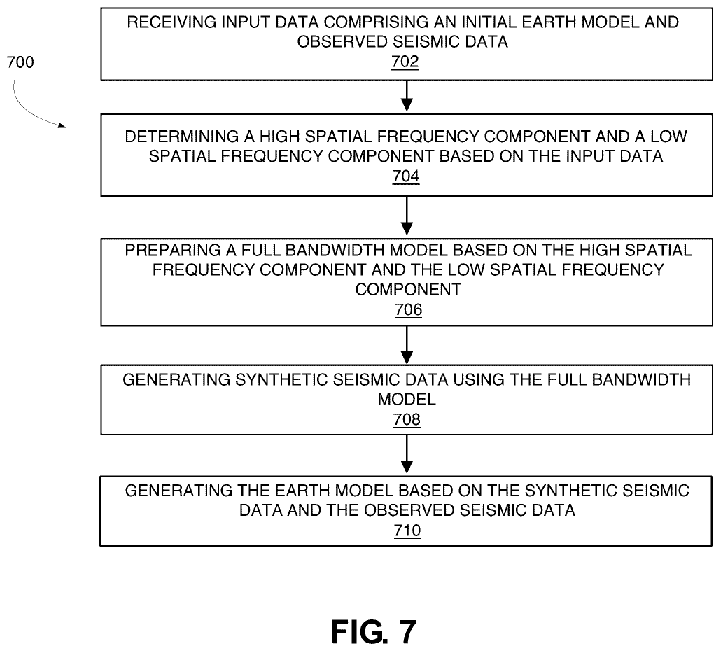

FIG. 7 illustrates a flowchart of a method 700 for generating an earth model, according to an embodiment. The method 700 may include receiving input data, wherein the input data comprises an initial earth model, observed seismic data, or any combination thereof, as at 702. The initial earth model may include an initial seismic vector reflectivity (R_{B}), an initial velocity (vₚ), or any combination thereof. The initial seismic vector reflectivity may include an acoustic reflectivity, an elastic impedance, a gradient of an impedance property, or a combination thereof.

The method 700 may also include determining a high spatial frequency component with the input data, as at 704. The high spatial frequency component may be determined with the initial earth model. The high spatial frequency component may be determined with the initial seismic vector reflectivity (R_{B}), the initial velocity (vₚ), or any combination thereof. The high spatial frequency component may be determined with the initial seismic vector reflectivity (R_{B}). The high spatial frequency component may be determined with the gradient of the impedance property. Determining the high spatial frequency component may include inverting the gradient of the impedance property of the initial seismic vector reflectivity (R_{B}) to the high spatial frequency component. The high spatial frequency component may be determined according to equation (20):

$${B}_{est} = {∇}^{†} {R}_{B} = {( {∇}^{′} ∇ + {ϵ}^{2} I )}^{- 1} {∇}^{′} {R}_{B} \qquad ( 20 )$$

where:
   Bₑₛₜ may be the high spatial frequency component of an impedance quantity of which the vector reflectivity (R_{B}) is the gradient; and
the impedance quantity may be an acoustic impedance or the elastic impedance.

The method 700 may further include determining a low spatial frequency component with the input data, as at 704. The low spatial frequency component may be determined with the initial earth model. The low spatial frequency component may be determined with the initial velocity (vₚ) of the initial earth model. Determining the low spatial frequency component with the input data may include determining an empirical component with the initial earth model of the input data based on an empirical model. The empirical component may be determined with the initial velocity (vₚ) of the initial earth model based on the empirical model. The empirical component may include an elastic impedance component, an acoustic impedance component, or any combination thereof. The empirical model may include Gardner's relationship, a defined relationship (vₚ/vₛ) between the initial velocity (vₚ) and a predicted shear velocity (vₛ), or any combination thereof. Determining the low spatial frequency component with the input data may also include determining the low spatial frequency component with the empirical component. Determining the low spatial frequency component with the empirical component may include low pass filtering of the empirical component. The low pass filtering may be expressed according to Equation (21):

$$( I - {∇}^{†} ∇ ) \qquad ( 21 )$$

The method 700 may also include preparing a full bandwidth model with the high spatial frequency component and the low spatial frequency component, as at 706. The method 700 may also include generating synthetic seismic data with the full bandwidth model, as at 708. The method 700 may also include generating the earth model based on the synthetic seismic data and the observed seismic data, as at 710. Generating the earth model may include comparing the synthetic seismic data with the observed seismic data.

In at least one embodiment, the full bandwidth model may be a full bandwidth elastic model. With respect to the full bandwidth elastic model, the initial seismic vector reflectivity may include a combination of the acoustic reflectivity, the elastic impedance, and the gradient of the impedance property. The empirical component may include a combination of the elastic impedance component and the acoustic impedance component. The empirical model may include Gardner's relationship and the defined relationship (vₚ/vₛ) between the initial velocity (vₚ) and the predicted shear velocity (vₛ). The low spatial frequency component may be determined according to Equation (22):

$${f}_{{v}_{p} \to B} ( {v}_{p} ) = log {v}_{p} - 4 {β}^{2} log [ {f}_{{v}_{p} \to ρ} ( {v}_{p} ) ] - 8 {β}^{2} log [ {f}_{{v}_{p} \to {v}_{s}} ( {v}_{p} ) ] \qquad ( 22 )$$

In at least one embodiment, the full bandwidth model may be a full bandwidth acoustic model. With respect to the full bandwidth acoustic model, the initial seismic vector reflectivity may include the acoustic reflectivity and the gradient of the impedance property. The gradient of the impedance property may be the gradient of an acoustic impedance property. The empirical component may include the acoustic impedance component, a density component, or any combination thereof. The empirical model may include Gardner's relationship. The low spatial frequency component may be determined according to Equation (23):

$${f}_{{v}_{p} \to A} ( {v}_{p} ) = log {v}_{p} + log [ {f}_{{v}_{p} \to ρ} ( {v}_{p} ) ] . \qquad ( 23 )$$

The method 700 may further include displaying the earth model. For example, the method 700 may include displaying the earth model on a display of a user interface. The method may also include performing an action in response to generating the earth model. The action may include generating and/or transmitting a signal that recommends, instructs, and/or causes a physical action to occur. The physical action may include selecting a drill location, selecting where to drill a wellbore, drilling the wellbore, varying a weight and/or torque on a drill bit that is drilling the wellbore, determining a location and/or amount of hydrocarbons in the subsurface formation and then varying a drilling trajectory of the wellbore toward the hydrocarbons, varying a concentration and/or flow rate of a fluid pumped into the wellbore, interpreting one or more geological events on the resultant data volume, or a combination thereof. The physical action may also include one or more exploratory related actions.

The steps in the processing methods described above may be implemented by running one or more functional modules in information processing apparatus such as general purpose processors or application specific chips, such as ASICs, FPGAs, PLDs, or other appropriate devices. These modules, combinations of these modules, and/or their combination with general hardware are included within the scope of protection.

Many processing techniques for collected data, including one or more of the techniques and methods disclosed herein, may also be used successfully with collected data types other than seismic data. While certain implementations have been disclosed in the context of seismic data collection and processing, those with skill in the art will recognize that one or more of the methods, techniques, and computing systems disclosed herein can be applied in many fields and contexts where data involving structures arrayed in a multi-dimensional space and/or subsurface region of interest may be collected and processed, e.g., medical imaging techniques such as tomography, ultrasound, MRI and the like for human tissue; radar, sonar, and LIDAR imaging techniques; mining area surveying and monitoring, oceanographic surveying and monitoring, and other appropriate multi-dimensional imaging problems.

Many examples of equations and mathematical expressions have been provided in this disclosure. But those with skill in the art will appreciate that variations of these expressions and equations, alternative forms of these expressions and equations, and related expressions and equations that can be derived from the example equations and expressions provided herein may also be successfully used to perform the methods, techniques, and workflows related to the embodiments disclosed herein.

While any discussion of or citation to related art in this disclosure may or may not include some prior art references, applicant neither concedes nor acquiesces to the position that any given reference is prior art or analogous prior art.

The foregoing description, for purpose of explanation, has been described with reference to specific embodiments. However, the illustrative discussions above are not intended to be exhaustive or to limit the present disclosure to the precise forms disclosed. Many modifications and variations are possible in view of the above teachings. The embodiments were chosen and described in order to explain the principles of the present disclosure and its practical applications, to thereby enable others skilled in the art to utilize the present disclosure and various embodiments with various modifications as are suited to the particular use contemplated.

Those with skill in the art will appreciate that while the quoted sections of the article above that are provided for illustrative purposes include terms that could be interpreted as potentially absolute or requiring a given thing (including without limitation “exactly”, “exact”, “only”, “key”, “important”, “requires”, “all”, “each”, “must”, “always”, etc.), the various systems, methods, processing procedures, techniques, and workflows disclosed herein are not to be understood as limited by the use of these terms

In some embodiments, the multi-dimensional region of interest includes one or more volume types selected from the group consisting of a subterranean region, human tissue, plant tissue, animal tissue, solid volumes, substantially solid volumes, volumes of liquid, volumes of gas/air, volumes of plasma, and volumes of space near and/or or outside the atmosphere of a planet, asteroid, comet, moon, or other body.

What is claimed is:

1. A method for generating an earth model, the method comprising:
receiving input data, wherein the input data comprises an initial earth model and observed seismic data;
determining a high spatial frequency component and a low spatial frequency component based on the input data;
preparing a full bandwidth model based on the high spatial frequency component and the low spatial frequency component;
generating synthetic seismic data using the full bandwidth model; and
generating the earth model based on the synthetic seismic data and the observed seismic data.

2. The method of claim 1, wherein:
the initial earth model comprises an initial seismic vector reflectivity (R_{B}); and
the high spatial frequency component is determined with the initial seismic vector reflectivity (R_{B}).

3. The method of claim 2, wherein:
the initial seismic vector reflectivity comprises an acoustic reflectivity and a gradient of an impedance property; and
the full bandwidth model is a full bandwidth acoustic model.

4. The method of claim 2, wherein the initial seismic vector reflectivity comprises a combination of an acoustic reflectivity, an elastic impedance, and a gradient of the impedance property.

5. The method of claim 4, wherein the full bandwidth model is a full bandwidth elastic model.

6. The method of claim 4, wherein determining the high spatial frequency component comprises inverting the gradient of the impedance property to the high spatial frequency component.

7. The method of claim 1, wherein generating the earth model based on the synthetic data and the observed seismic data comprises comparing the synthetic seismic data with the observed seismic data.

8. The method of claim 1, wherein determining the low spatial frequency component with the input data comprises:
determining an empirical component with the initial earth model using an empirical model; and
determining the low spatial frequency component with the empirical component.

9. The method of claim 1, further comprising displaying the earth model.

10. The method of claim 1, performing an action in response to generating the earth model, wherein the action includes generating and/or transmitting a signal that recommends, instructs, or causes a physical action to occur, and wherein the physical action includes selecting where to drill a wellbore, drilling the wellbore, varying a weight and/or torque on a drill bit that is drilling the wellbore, determining a location and/or amount of hydrocarbons in the subsurface formation and then varying a drilling trajectory of the wellbore toward the hydrocarbons, varying a concentration and/or flow rate of a fluid pumped into the wellbore, interpreting one or more geological events, or a combination thereof.

11. A computing system, comprising:
one or more processors; and
a memory system comprising one or more non-transitory computer-readable media storing instructions that, when executed by at least one of the one or more processors, cause the computing system to perform operations, the operations comprising:
receiving input data, wherein the input data comprises an initial earth model and observed seismic data, and wherein the initial earth model comprises an initial seismic vector reflectivity (R_{B}), an initial velocity (vₚ), or any combination thereof;
determining a high spatial frequency component based on the initial seismic vector reflectivity (R_{B});
determining a low spatial frequency component using the initial earth model, wherein determining the low spatial frequency component comprises:
determining an empirical component using the initial earth model based on an empirical model;
determining the low spatial frequency component based on the empirical component,
preparing a full bandwidth model based on the high spatial frequency component and the low spatial frequency component;
generating synthetic seismic data using the full bandwidth model;
generating the earth model based on the synthetic seismic data and the observed seismic data.

12. The computing system of claim 11, wherein generating the earth model comprises comparing the synthetic seismic data with the observed seismic data.

13. The computing system of claim 11, wherein the initial seismic vector reflectivity comprises an acoustic reflectivity, an elastic impedance, a gradient of an impedance property, or a combination thereof.

14. The computing system of claim 13, wherein:
the initial seismic vector reflectivity comprises a combination of the acoustic reflectivity and the gradient of the impedance property;
the empirical model comprises Gardner's relationship; and
the full bandwidth model is a full bandwidth acoustic model.

15. The computing system of claim 13, wherein:
the initial seismic vector reflectivity comprises a combination of the acoustic reflectivity, the elastic impedance, and the gradient of the impedance property;
the empirical component comprises a combination of an elastic impedance component and an acoustic impedance component; and
the full bandwidth model is a full bandwidth elastic model.

16. A non-transitory computer-readable medium storing instructions that, when executed by one or more processors of a computing system, cause the computing system to perform operations, the operations comprising:
receiving input data, wherein the input data comprises an initial earth model and observed seismic data, wherein the initial earth model comprises an initial seismic vector reflectivity (R_{B}) and an initial velocity (vₚ), and wherein the initial seismic vector reflectivity comprises an acoustic reflectivity, an elastic impedance, a gradient of an impedance property, or a combination thereof;
determining a high spatial frequency component based on the gradient of the impedance property;
determining a low spatial frequency component based on the initial velocity (vₚ) of the initial earth model, wherein determining the low spatial frequency component comprises:
determining an empirical component with the initial velocity (vₚ) using an empirical model; and
applying a low pass filtering to the empirical component to determine the low spatial frequency component;
preparing a full bandwidth model based on the high spatial frequency component and the low spatial frequency component;
generating synthetic seismic data using the full bandwidth model;
generating the earth model based on the synthetic seismic data and the observed seismic data, wherein generating the earth model comprises comparing the synthetic seismic data with the observed seismic data.

17. The non-transitory computer-readable medium of claim 16, wherein determining the high spatial frequency component comprises inverting the gradient of the impedance property to the high spatial frequency component.

18. The non-transitory computer-readable medium of claim 16, wherein:
the empirical component comprises an elastic impedance component, an acoustic impedance component, a density component, or any combination thereof; and
the empirical model comprises Gardner's relationship, a defined relationship (vₚ/vₛ) between the initial velocity (vₚ) and a predicted shear velocity (vₛ), or any combination thereof.

19. The non-transitory computer-readable medium of claim 16, wherein:
the initial seismic vector reflectivity comprises the acoustic reflectivity and the gradient of the impedance property;
the empirical component comprises one or more of an acoustic impedance component, a density component, or a combination thereof;
the empirical model comprises Gardner's relationship; and
the full bandwidth model is a full bandwidth acoustic model.

20. The non-transitory computer-readable medium of claim 16, wherein:
the initial seismic vector reflectivity comprises a combination of the acoustic reflectivity, the elastic impedance, and the gradient of the impedance property;
the empirical component comprises a combination of an elastic impedance component and an acoustic impedance component;
the empirical model comprises Gardner's relationship and a defined relationship (vₚ/vₛ) between the initial velocity (vₚ) and a predicted shear velocity (vₛ); and
the full bandwidth model is a full bandwidth elastic model.
